(19) United States
(12) Patent Application Publication
(10) Pub. No.: US 2018/0147975 A1
(43) Pub. Date: May 31, 2018

(54) LOAD HOLDING SYSTEM AND METHOD

(71) Applicant: ALUMINIUM INDUSTRIES INVESTMENTS PTY LTD, Brighton (AU)

(72) Inventors: James Gallagher, Brighton (AU); Matthew Keen, Brighton (AU)

(21) Appl. No.: 15/882,971

(22) Filed: Jan. 29, 2018

Related U.S. Application Data
(63) Continuation of application No. PCT/AU2016/050690, filed on Jul. 29, 2016.

(30) Foreign Application Priority Data
Jul. 30, 2015 (AU) 2015903034

(51) Int. Cl. B60P 7/08

(52) U.S. Cl. CPC B60P 7/0815; B60P 7/0846

(57) ABSTRACT

A load holding system for use with a load bearing surface and for use with a tether includes at least one anchoring device adapted to releasably engage with the tether and at least one channel in or on the loading bearing surface. The channel has an opening, and the channel and the anchoring device are adapted to releasably engage with each other. When the anchoring device is subject to a holding force in a given direction, one or more engagement surfaces of the anchoring device frictionally engage with a respective one or more engagement surfaces of the channel such that the anchoring device is held in place at a selected position along the channel. When the anchoring device is not subject to the holding force, the anchoring device is slidable along the channel.

### CROSS-REFERENCE TO RELATED APPLICATIONS

This application is a continuation of International Application No. PCT/AU2016/050690 with a filing date of 29 Jul. 2016, which claims priority to Australian Application No. 2015903034 with a filing date of 30 Jul. 2015, the disclosures of which are incorporated herein by reference.

### FIELD OF THE INVENTION

The present invention relates to systems and methods for holding a load onto a load bearing service, and may be particularly useful for holding loads onto the tray of a vehicle such as a utility truck.

### BACKGROUND OF THE INVENTION

Currently, when holding or securing a load to a load bearing surface, such as a utility vehicle tray, ropes and ratchets, and the like, are used for securing the load to the surface. However, these techniques, methods and equipment can be messy and unsafe because there is no point or points adjacent or near to the load on the load bearing surface to secure the ropes. Tie down points are provided at or towards the sides of the load bearing surface, such as at the sides of a utility vehicle tray, however, when desiring to hold large or multiple items across a load bearing surface, there is presently no ability to adaptably organise tie down points intermediate the side-located tie down points. This can cause the load to be tied to the load bearing surface in an unsafe and disorganised manner.

For example, as shown in FIG. 1, when tying an upright bicycle 10 to a utility vehicle tray 20, the rope or strap 30 may be passed over a point on the bicycle, such as over the wheel arch 40 of the bicycle, and then tied on either side 50 of the utility vehicle tray. The down force provided by such a method and system can be insufficient to keep the bicycle in place when the vehicle is moving and subject to forces, for example, on bumpy roads or when the vehicle is travelling around corners. Items tied to a utility vehicle tray in such a way can easily fall off onto the road.

Another example is shown in FIG. 2 with a utility vehicle 60 carrying various items, such as an icebox 70, a spare wheel 80, a large toolbox 90, and another large item 100 on the vehicle tray 20. As can be seen the straps 30 are tied from sides of the vehicle then over the item to be secured, but the straps are not anchored or tied in any way .at a point close to the side of the item to be secured on the utility vehicle tray 20. Again, in such a configuration, the down force provided by this tying method may be insufficient to retain the items in place, especially on very bumpy paths and roads, as shown in FIG. 2.

Another problem with such methods and systems of securing loads onto a load bearing surface, such as a utility vehicle tray, as shown in FIG. 3, is that the side gates 110 of such a vehicle 60 can be subject to deformation due to tensioning rope or straps 130 around them. Sometimes, the side gates may provide the only fixing point 140 on the perimeter of the tray of a utility vehicle to hold an item 120 in place.

In order to address this problem, some load bearing surfaces in utility vehicle trays have incorporated eyelet fixings across the utility tray at fixed locations. However, this does not solve the problem because eyelets at fixed location cannot be adjusted for loads of different shapes and size. Further, if attempting to use eyelets at fixed locations, the maximum down force cannot be provided for each item being tied to the utility vehicle tray. This may be particularly important for items carried on the load bearing surface at the centre of the surface, where a point force could be required at either side of the load to provide maximum downward force of the load to the load bearing surface.

It is an object of the present invention to overcome, or at least ameliorate, at least one of the above-mentioned problems in the prior art, and/or to overcome, or at least ameliorate, at least one problem in the prior art, which has not been mentioned above and/or to provide at least a useful alternative to prior art devices, systems and/or methods.

### SUMMARY OF THE INVENTION

In one aspect, the present invention provides a load holding system for use with a load bearing surface and for use with a tether, the load holding system including at least one anchoring device adapted to releasably engage with the tether, and, at least one channel located in or on the load bearing surface, the channel having an opening and the channel and the anchoring device adapted to releasably engage with each other, wherein, when the anchoring device is subject to a holding force in a given direction, one or more engagement surfaces of the anchoring device frictionally engage with a respective one or more engagement surfaces of the channel such that the anchoring device is held in place at a selected position along the channel, and wherein, when the anchoring device is not subject to the holding force, the anchoring device is slidable along the channel.

In another aspect, the present invention provides a method of securing a load to a load bearing surface using a load holding system for use with a load bearing surface and for use with a tether, the load holding system including at least one anchoring device adapted to releasably engage with the tether, and, at least one channel located in or on the load bearing surface, the channel having an opening and the channel and the anchoring device adapted to releasably engage with each other, wherein, when the anchoring device is subject to a holding force in a given direction, one or more engagement surfaces of the anchoring device frictionally engage with a respective one or more engagement surfaces of the channel such that the anchoring device is held in place at a selected position along the channel, and wherein, when the anchoring device is not subject to the holding force, the anchoring device is slidable along the channel, the method including placing a first part of the load on the load bearing surface, placing the anchoring device in a channel located under the load, and sliding the anchoring device to be close to the load, placing a second part of the load on the load bearing surface, on the other side of the anchoring device with respect to the first part of the load, engaging the anchoring device with the tether, and engaging both end parts of the tether on respective sides of the load bearing surface at or near ends of the channel, such that the tether is over the first and second parts of the load, and applying a tethering force to the tether via the engagement of one or both end part thereof, the tethering force sufficient to tauten the tether and to provide the holding force to the anchoring device, and such that the first and second parts of the load are secured to the load bearing surface.

In one embodiment, the anchoring device includes an opening into or through which the tether can be fed for engagement of the anchoring device with the tether.

In another embodiment, the anchoring device opening comprises one of an eyelet and a slot.

In yet another embodiment, the channel includes rails along the edges of the channel opening, the rails including the channel engagement surfaces, and wherein the anchoring device includes lugs on opposing sides thereof, the lugs including the anchoring device engagement surface.

In a further embodiment, the channel opening is at or near the load bearing surface so as to be substantially flush with the load bearing surface.

In yet a further embodiment, the channel is formed in a beam having an opening along one side thereof, the beam opening forming the channel opening.

In an optional embodiment, the beam is located in a complementary slot formed in the load bearing surface. The beam and complementary slot may include at least one tongue and groove engagement means.

In another optional embodiment, the holding force is provided by the tether when engaged with the anchoring device and when the tether is taut. The tether may be taught when subject to a tethering force.

In another embodiment, the tethering force or forces is/are provided by tethering one or both end parts of the tether at or near one or both respective sides of the load holding surface.

In yet another embodiment, at least one end part of the tether is adapted to be engaged by a tether winding mechanism located at or near a side of the load bearing surface. Further, both end parts of the tether may be adapted to be engaged by respective tether winding mechanisms, each tether winding mechanism located at or near a respective side of the load bearing surface. In an optional variation, the or each tether winding mechanism includes a ratchet mechanism.

In a further embodiment, the tether includes a hook at at least one end thereof, and wherein the hook is adapted to engage with the opening in the anchoring device. The hook may be adapted to engage with an opening in the load bearing surface, the load bearing surface opening located at or near an end of the channel.

In one embodiment, the tether comprises one of a strap and a rope.

In a further embodiment, the load bearing surface is a tray of a utility vehicle.

In an optional embodiment, the system includes a plurality of parallel channels substantially evenly spaced apart along the load bearing surface.

In another embodiment, the load holding system includes the tether.

In yet another optional embodiment, the load holding system includes the or each winding mechanism.

In another optional embodiment, the load holding system includes the load bearing surface.

In an embodiment, the load holding system further includes a frictional insert adapted to be placed in the channel, wherein, when in the channel, the insert protrudes from the channel opening, and wherein a surface of the insert frictionally engages with a surface of a load on the load bearing surface, such that the insert assists in stabilizing the load with respect to movement of the load substantially in the plane of the load bearing surface. In this embodiment, the insert may include a slot located at each side thereof for engagement with respective engagement surfaces of the channel. In one variation, the insert is flexible such that, when the load is against the insert, the insert flexes towards the channel with a resultant force towards the load. Optionally, the insert may be formed from one of plastic, rubber, or a rubber-like substance.

In another embodiment the holding system is further adapted to accept one or more of a load, equipment, a device, a structural member, and a box, wherein the channel and the one or more of the load, the equipment, the device, the structural member, and a box are adapted to engage with each other. In a variation of this embodiment, the one or more of the load, equipment, the device, the structural member, and a box each include at least one anchoring member, wherein the channel and the at least one anchoring member are adapted to releasably engage with each other, wherein, when the at least one anchoring member is subject to a holding force in a given direction, one or more engagement surfaces of the anchoring member frictionally engage with a respective one or more engagement surfaces of the channel such that the anchoring member is held in place at a selected position along the channel, and wherein, when the anchoring member is not subject to the holding force, the anchoring device is slidable along the channel.

### BRIEF DESCRIPTION OF THE DRAWINGS

Various embodiments of the invention will be described with reference to the following, non-limiting illustrations representing various embodiments of the present invention.

FIG. 1 is a front elevation view of prior art showing a load, in this example a bicycle, tied to a utility vehicle tray with a strap.

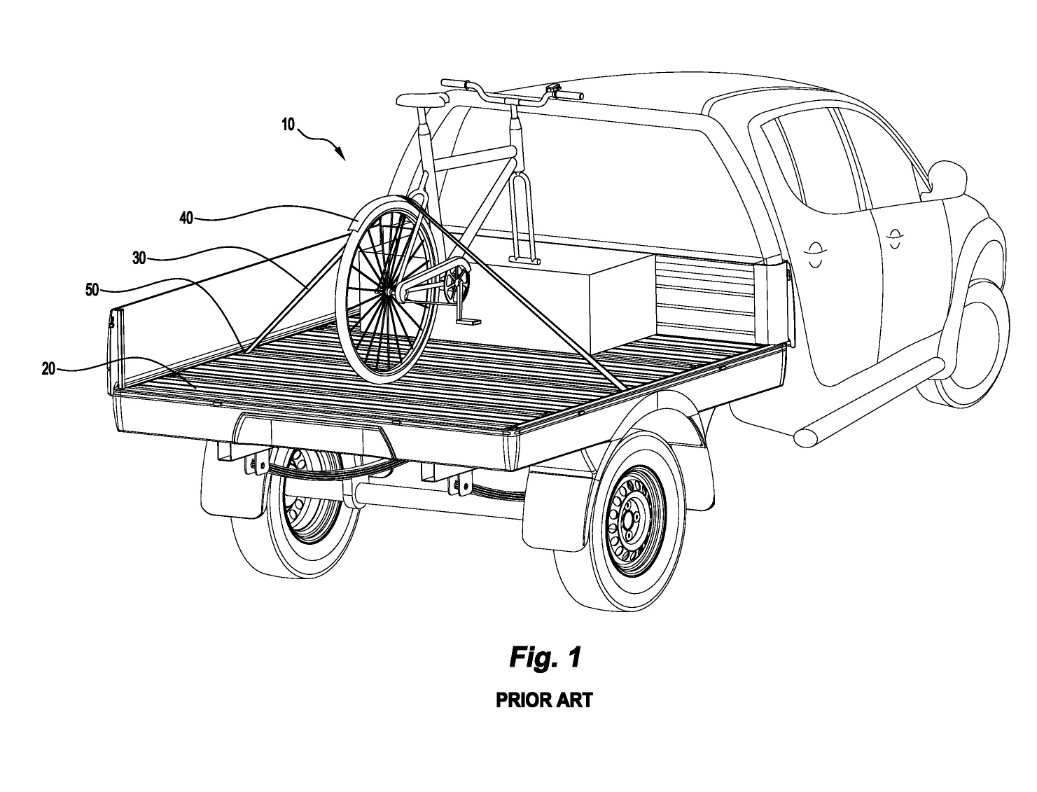

FIG. 2 is a rear perspective view of prior art showing the tray of a utility vehicle carrying a load of different items, each tied to the tray of the utility vehicle with a strap.

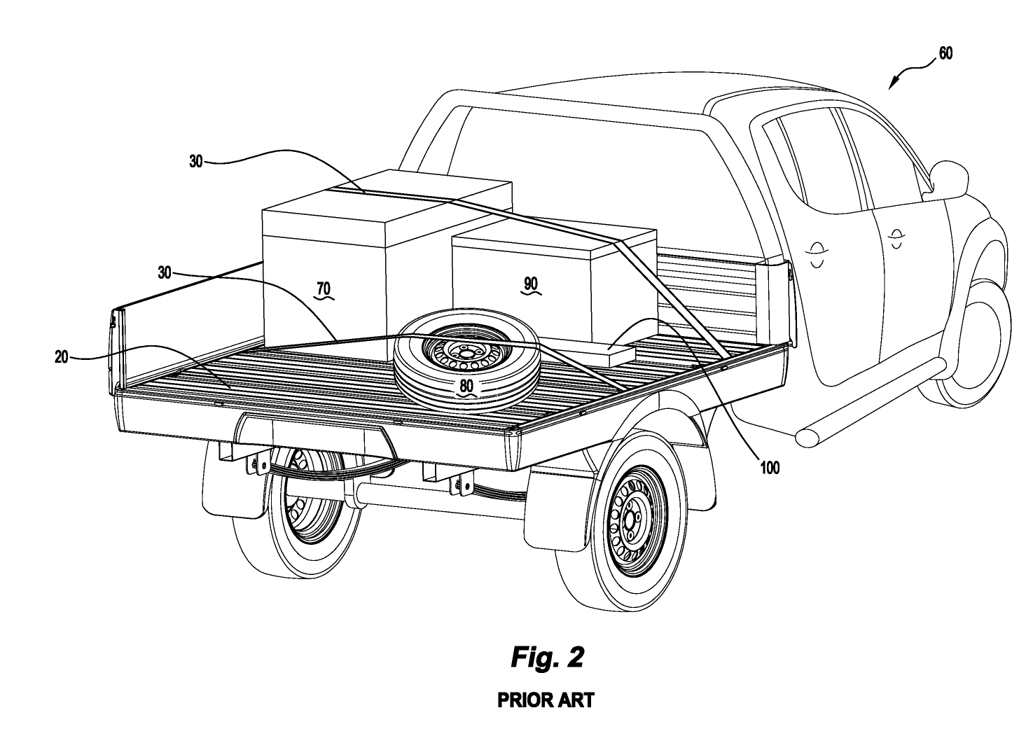

FIG. 3 is a rear perspective view of prior art, showing a utility vehicle with an elongate load tied to the tray using a strap secured at the side members of the utility vehicle.

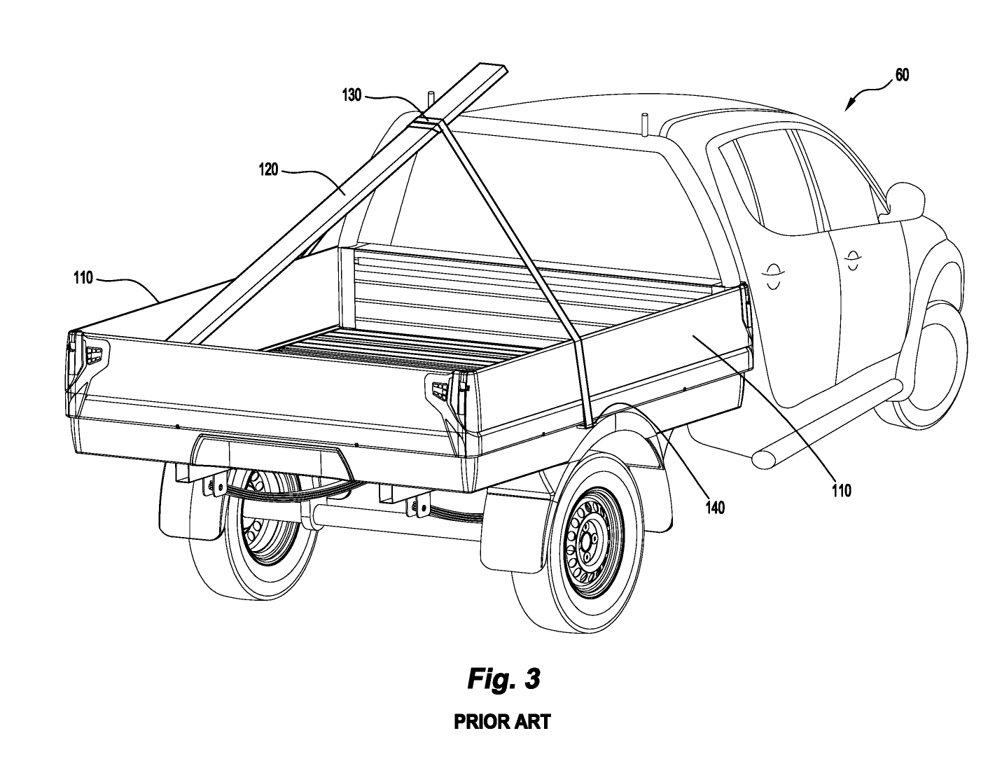

FIG. 4 is a front elevation cross-sectional view of an embodiment of the present invention, showing a channel and an anchoring device.

FIG. 5 is an elevated perspective view of an embodiment of the present invention, showing different items held on the tray of a utility vehicle.

FIG. 6 is a side perspective view of an embodiment of the present invention, showing a strap with a hook engaging an anchoring member, which is in turn engaged with a channel.

FIG. 7 is a side perspective view of an embodiment of the present invention, similar to that shown in FIG. 6.

FIG. 8 is a rear corner perspective view of an embodiment of the present invention, showing a number of different items tied to the deck of a utility vehicle.

FIG. 9 is a side perspective view of an embodiment of the present invention, showing straps being tethered at or near the side of the tray of a utility vehicle.

FIG. 10 is a side perspective view of another embodiment of the present invention, showing a different method of tethering the straps at the side of the tray of a utility vehicle.

FIG. 11 is a side cross-sectional view of an embodiment of the present invention showing an insert in the channel with a load on top of the insert.

### DETAILED DESCRIPTION OF THE INVENTION

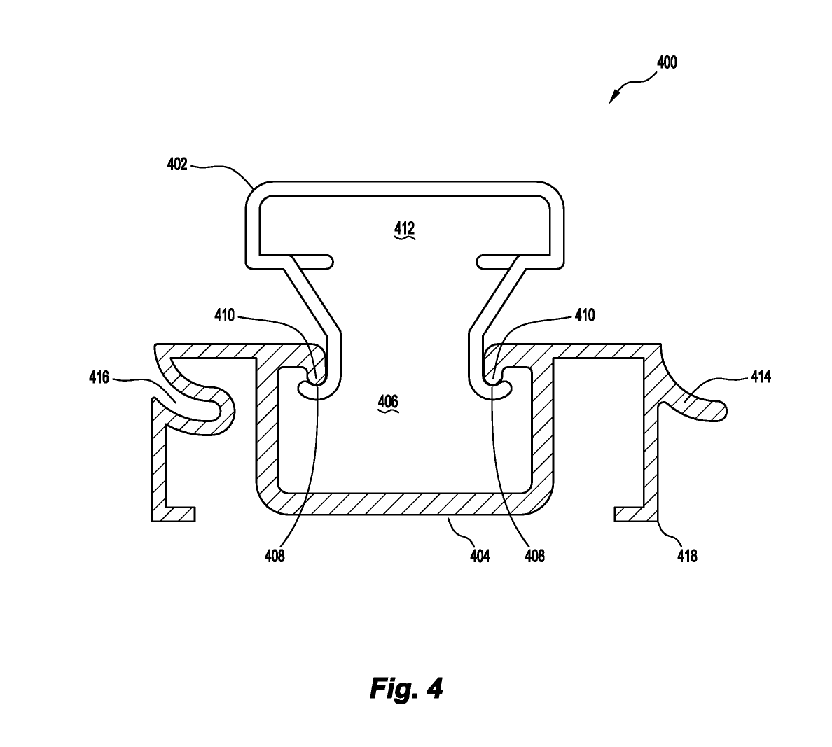

FIG. 4 shows an embodiment of the present invention depicting the system 400 including an anchoring device 402 and a channel 404. The anchoring device is sufficiently thin in one plane that it can be inserted into an opening 406 in the channel 404 when turned longitudinally for such insertion. The anchoring device 402 is then turned approximately 90 degrees so that the engagement surfaces 408 of the anchoring device engage with respective engagement services 410 of the channel 404.

When the anchoring device 402 is subjected to an upward force (relative to the orientation of the system 400 as shown in FIG. 4), the engagement surfaces 408 of the anchoring device 402 frictionally engage with the engagement surfaces 410 of the channel 404 such that the anchoring device is held in place at a selected position along the channel. When the holding force is slackened or released, the anchoring device 402 can be slid along the channel 404, or can be lowered, twisted approximately 90 degrees, and removed from the channel.

The anchoring device 402 includes an opening 412, through which the tether (not shown in FIG. 4) can be fed for engagement of the anchoring device with the tether. In this embodiment, the opening 412 in the anchoring device 402 takes the form of a slot, but could be an eyelet or any other shape or configuration suitable for the purpose of retaining the tether when the tether provides the holding force. The tether provides the holding force when it is taut, and the tautness is usually provided by tying off the tether at or towards the ends of the channel. Tying or tethering the tether at the channel end provides the tethering force to keep the tether taut.

In the embodiment shown in FIG. 4, the engagement surfaces 408 of the anchoring device 402 are provided by outwardly facing lugs or hooks positioned towards the bottom of the anchoring device. The engagement surfaces 410 of the channel 404 are provided by rails, which run along the edges of the channel opening 406.

It will be appreciated that the channel and the anchoring device are formed from materials which have sufficient resilience and stiffness to withstand the holding force and other such forces that may be applied, for example, when a load on a load bearing surface is subjected to accelerations as can happen on bumpy roads or around corners in a utility vehicle. Such materials may include steel, aluminium and other sufficiently stiff metals.

The channel 404 is formed in a beam 418. At the sides of the beam there are a tongue 414 and groove 416, which are adapted for engagement with a complementary tongue and groove system formed in a complementary slot in a load bearing surface (load bearing surface not shown in FIG. 4).

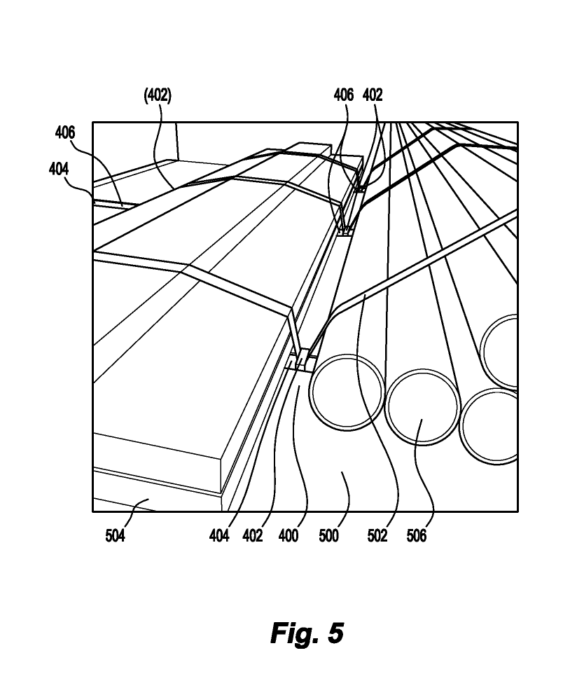

FIG. 5 shows an embodiment of the system 400 in use when holding a load onto a load bearing surface 500. The load bearing surface is depicted with three channels 404, and elongate items, such as timber planks 504 and pipes 506 are shown placed orthogonally to the channels. Anchoring devices 402 are shown intermediate the different load items 504, 506 in each of the channels with tethers 502 threaded through the slot of each anchoring device.

Towards the left of FIG. 5 and out of sight is an anchoring device in the mid-most channel. This anchoring device is placed at or near the side of the timber plank load 504 with a tether 502 threaded through its opening. The same arrangement applies for each of the channels depicted in FIG. 5.

When the tethers 502 are tethered at or towards the ends of the channels 404, the tethers are subjected to a tethering force which causes the tethers to become taut, and the tautness of the tethers transfers a holding force to each of the anchoring devices, such that each anchoring device is pulled upwardly and the engagement surfaces of the anchoring device frictionally engage with the respective engagement surfaces of the channel so that the anchoring device is held in place. Further to this, the tautness of the tethers holds the load items 504, 506 in place on the load bearing surface 500. It will be appreciated that the anchoring devices may be seen as providing an intermediate tethering point between the load items 504 and 506, and a tethering point on the outer sides of the load items 504 and 506. Providing these intermediate tethering points located between the sides of the load bearing surface allows a greater downward force to be applied to the load items than if the items were merely held in place by the tethers being tethered at the sides of the load bearing surface.

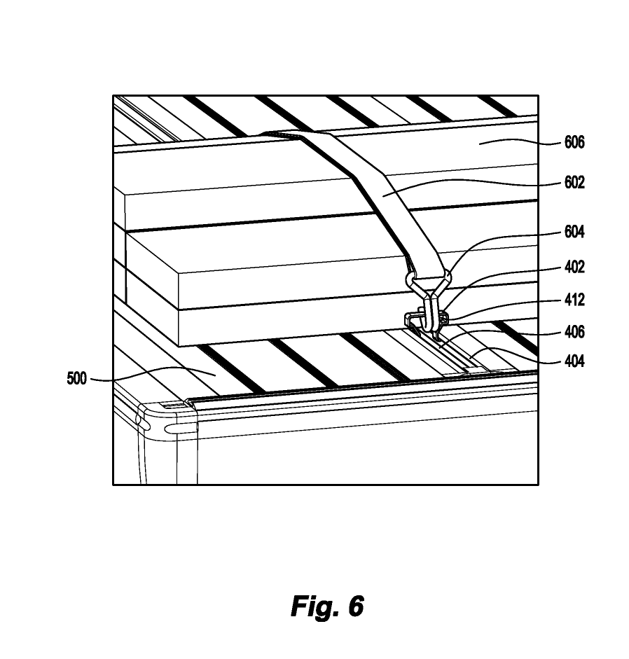

FIG. 6 shows another optional variation wherein a tethering strap 602 has a hook 604 at one end thereof, and the hook engages with the opening 412 of the anchoring device 402, such that, when the strap 602 is pulled taut, the holding force is provided through the hook 604 to the anchoring device 402, which is held in its position along the channel 404. This variation can be useful if it is desired not to have the tether tied off at sides of a load bearing surface 500, such as in a utility vehicle tray.

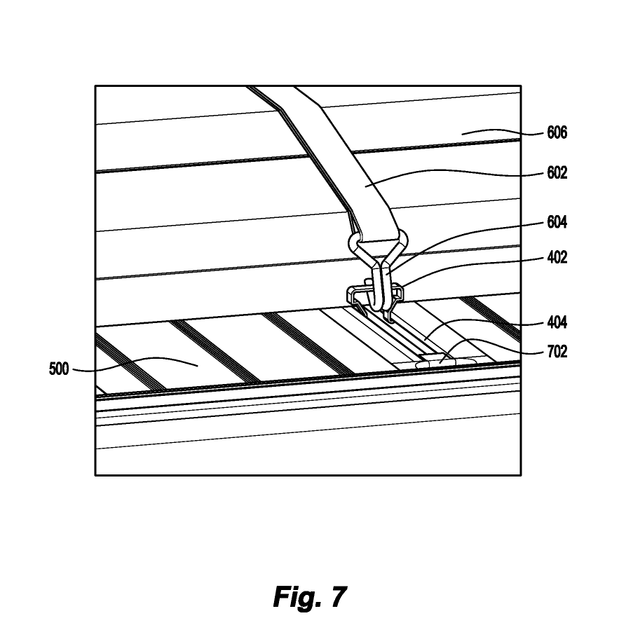

FIG. 7 is a zoomed-out view of the variation shown in FIG. 6. It can be more readily seen that the items in the load 606 are held down by the hook 604 and anchoring device 402 away from the side of the load bearing surface 500, which is away from the tie-off point 702.

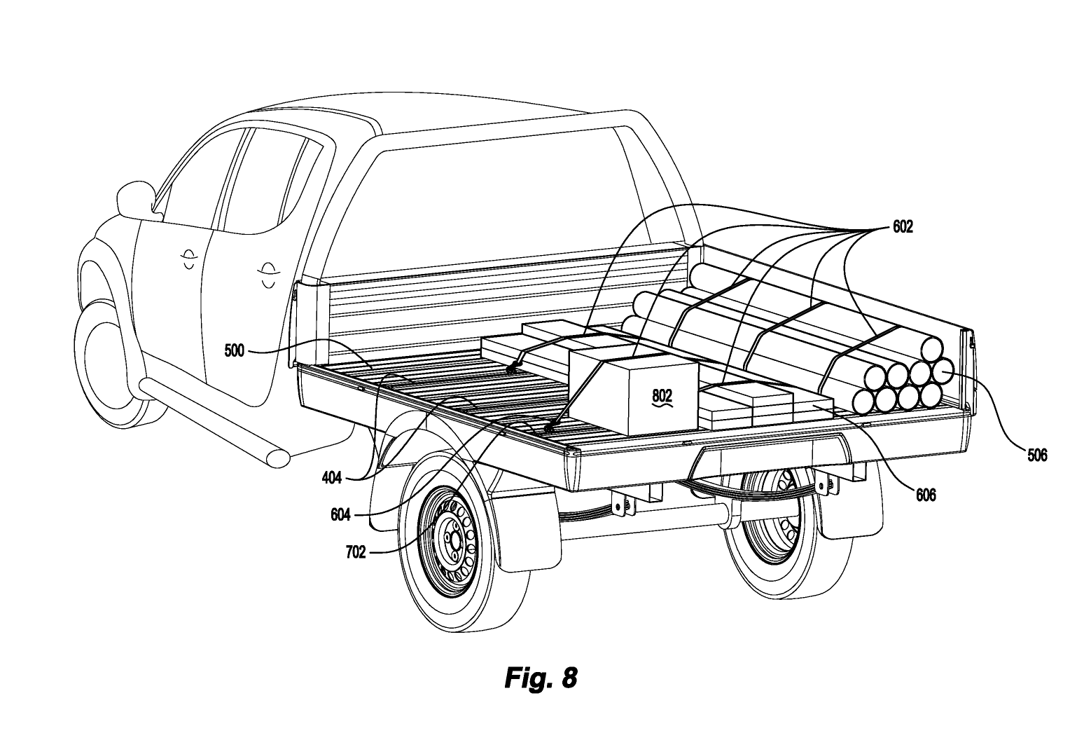

FIG. 8 shows yet another variation, wherein the load bearing surface 500 has slots 702, which can act as points of engagement for the hook 604 towards the side of the load bearing surface. This allows for certain load items 802 to be placed closer to the edges of the edge of the load bearing surface, but to be subjected to greater downward tethering force, so as to be more-securely tied to the utility vehicle tray.

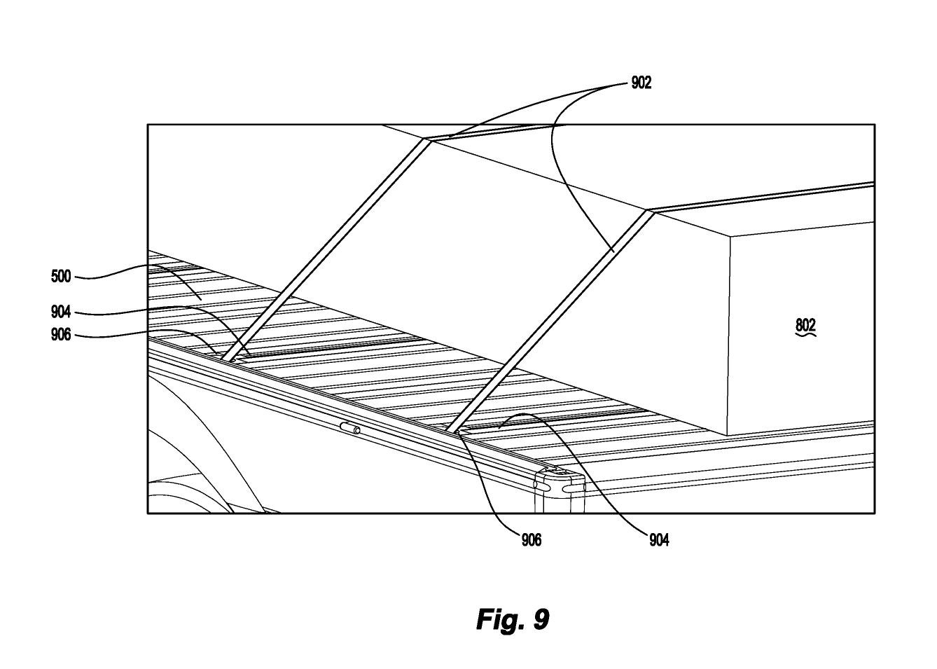

FIG. 9 shows another embodiment, in which tethers 902 can be tethered using a winding tethering device, such as a ratchet winch. As shown in FIG. 9 these can be concealed under the load bearing surface with the tether 902 being passed through a slot 906 to engage with the winding tethering device.

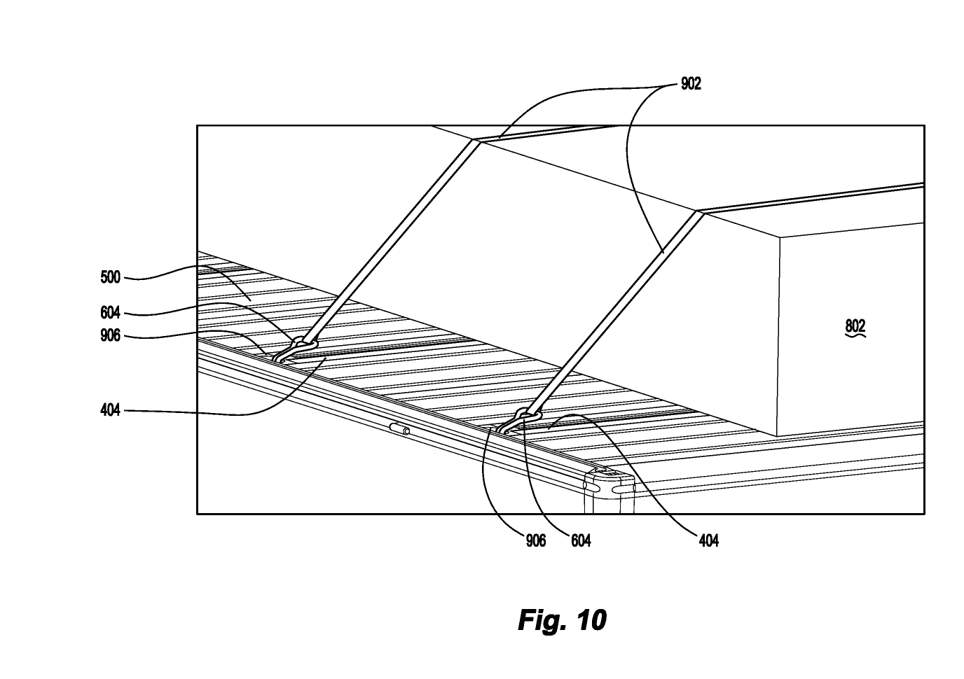

FIG. 10 shows a variation in which the slots 906 can be used as anchoring points for the hooks 604.

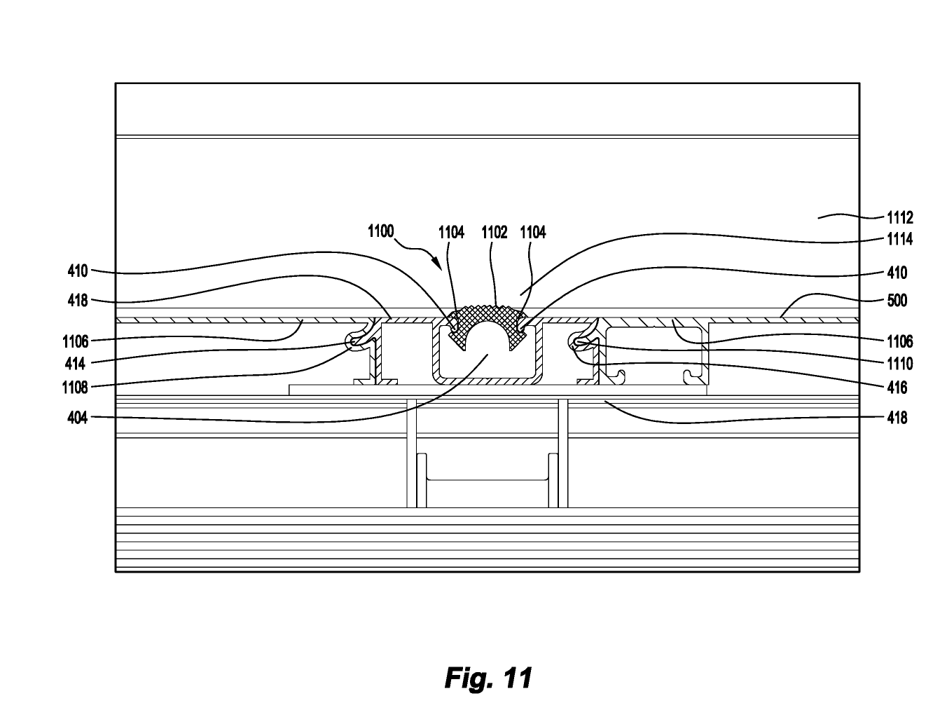

FIG. 11 shows an additional device to be used with embodiments of the invention, being a rubber, or rubber-like compound insert, which is inserted into the opening 406 of the channel 404. The rubber insert 1100, may be comprised of any suitable substance to provide flexibility, such that when a load 1112 is placed upon the insert, it flexes downwardly. The insert compound should also provide some sort of frictional engagement with the load to prevent sliding in a horizontal direction across the load bearing surface 500.

Additionally, the insert 1100 may have gripping 1102, which assists with providing friction between the rubber insert and the load 1112.

Also depicted in FIG. 11 is the channel 404 formed in a beam 418. The beam is inserted into a complementary slot 1114, formed in the load bearing surface 500. The beam 418 includes a tongue 414 and groove 416, each of which engage with a complementary respective groove 1108 and tongue 1110 formed in or onto struts 1106, which comprise the load bearing surface 500.

The rubber insert 1100 includes channels 1104, which engage with respective complementary rails 410 along the opening 406 of the channel 404.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge.

1. A load holding system for use with a load bearing surface and for use with a tether, the load holding system comprising:
at least one anchoring device adapted to releasably engage with the tether; and,
at least one channel located in or on the load bearing surface, the channel having an opening and the channel and the anchoring device adapted to releasably engage with each other,
wherein, when the anchoring device is subject to a holding force in a given direction, one or more engagement surfaces of the anchoring device frictionally engage with a respective one or more engagement surfaces of the channel such that the anchoring device is held in place at a selected position along the channel,
wherein, when the anchoring device is not subject to the holding force, the anchoring device is slidable along the channel, and
wherein the load bearing surface is a tray of a utility vehicle.

2. A load holding system according to claim 1, wherein the utility vehicle has a longitudinal axis, and the at least one channel in the load bearing surface is transversely oriented to the longitudinal axis.

3. A load holding system according to claim 2, wherein the anchoring device comprises an opening into or through which the tether can be fed for engagement of the anchoring device with the tether, and wherein the anchoring device opening comprises an eyelet or a slot.

4. A load holding system according to claim 2, wherein the channel includes rails along the edges of the channel opening, the rails including the channel engagement surfaces, and wherein the anchoring device includes lugs on opposing sides thereof, the lugs including the anchoring device engagement surfaces.

5. A load holding system according to claim 2, wherein the channel is formed in a beam having an opening along one side thereof, the beam opening forming the channel opening.

6. A load holding system according to claim 2, wherein the holding force is provided by the tether when engaged with the anchoring device and when the tether is taut.

7. A load holding system according to claim 6, wherein the tether is taut when subject to a tethering force.

8. A load holding system according to claim 2, wherein at least one end part of the tether is adapted to be engaged by a tether winding mechanism located at or near a side of the load bearing surface.

9. A load holding system according to any claim 2, wherein the tether includes a hook at least at one end thereof, and wherein the hook is adapted to engage with the opening in the anchoring device.

10. A load holding system according to claim 9, wherein the hook is adapted to engage with an opening in the load bearing surface, the load bearing surface opening located at or near an end of the channel.

11. A load holding system according to claim 2, wherein the system includes a plurality of parallel channels substantially evenly spaced apart along the load bearing surface.

12. A load holding system according to claim 2, wherein the load holding system includes the tether.

13. A load holding system according to claim 2, wherein the load holding system includes the load bearing surface.

14. A load holding system according to claim 2, further comprising a frictional insert adapted to be placed in the channel, wherein, when in the channel, the insert protrudes from the channel opening, and wherein a surface of the insert frictionally engages with a surface of a load on the load bearing surface, such that the insert assists in .stabilizing the load with respect to movement of the load substantially in the plane of the load bearing surface.

15. A load holding system according to claim 14, wherein the insert includes a slot located at each side thereof for engagement with respective engagement surfaces of the channel.

16. A load holding system according to claim 14, wherein the insert is flexible such that, when the load is against the insert, the insert flexes towards the channel with a resultant force towards the load.

17. A load holding system according to claim 14, wherein the insert is formed from one of plastic, rubber, or a rubber-like substance.

18. A load holding system according to claim 2, further adapted to accept one or more of a load, equipment, a device, a structural member, and a box, wherein the channel and the one or more of the load, the equipment, the device, the structural member, and a box are adapted to engage with each other.

19. A load holding system according to claim 18, wherein the one or more of the load, the equipment, the device, the structural member, and a box each include at least one anchoring member, wherein the channel and the at least one anchoring member are adapted to releasably engage with each other, wherein, when the at least one anchoring member is subject to a holding force in a given direction, one or more engagement surfaces of the anchoring member frictionally engage with a respective one or more engagement surfaces of the channel such that the anchoring member is held in place at a selected position along the channel, and wherein, when the anchoring member is not subject to the holding force, the anchoring device is slidable along the channel.

20. A method of securing a load to a load bearing surface using the load holding system according to claim 2, the method comprising:
placing a first part of the load on the load bearing surface;
placing the anchoring device in a channel located under the load, and sliding the anchoring device to be close to the load; placing a second part of the load on the load bearing surface, on the other side of the anchoring device with respect to the first part of the load;
engaging the anchoring device with the tether, and engaging both end parts of the tether on respective sides of the load bearing surface at or near ends of the channel, such that the tether is over the first and second parts of the load; and
applying a tethering force to the tether via the engagement of one or both end part thereof, the tethering force sufficient to tauten the tether and to provide the holding force to the anchoring device, and such that the first and second parts of the load are secured to the load bearing surface.
